(19) United States
(12) Patent Application Publication
(10) Pub. No.: US 2005/0238453 A1
(43) Pub. Date: Oct. 27, 2005

(54) Wheelchair locking device

(76) Inventor: Christian Lemay, St-Lambert (CA)

Correspondence Address: Franz BONSANG;c/o PROTECTIONS EQUINOX INT'L INC., Suite 224, 4480, Cote-de-Liesse, Montreal, QC, H4N 2R1, CA

(21) Appl. No.: 10/829,957

(22) Filed: Apr. 23, 2004

(51) Int. Cl. B60P 3/06

(52) U.S. Cl. 410/7

(57) ABSTRACT

A locking device for mounting a wheelchair in a vehicle, in which the wheelchair has a downwardly depending locking pin. The device includes two plate members and a connecting portion, which connects the plate members. The plate members are movable with respect to each other about the connecting portion and mate together to retain the locking pin between the plate members.

### FIELD OF THE INVENTION

The present invention concerns locks and more particularly to locks to stabilize wheelchairs in a vehicle.

### BACKGROUND OF THE INVENTION

Transporting wheelchair-bound individuals is an on-going challenge, especially since the wheelchairs are bulky and awkward to maneuver in confined spaces such as within an interior of a vehicle. Once the wheelchair is located in the vehicle, another challenge is to stabilize the wheelchair to reduce its movement during transportation. To aid locking, the wheelchairs often have to be adapted such as by connecting a downwardly depending locking pin to a lower part of the wheelchair's frame. The locking pin is guided into a lock housing mounted on the vehicle's floor and which retains the pin and therefore the wheelchair. A number of designs exist which address the aforesaid challenges, a few examples of which are:
U.S. Pat. No. 4,062,209, issued Dec. 13, 1977 to Downing et al., for “Wheelchair Lock”;
U.S. Pat. No. 5,092,722, issued Mar. 3, 1992 to Reazer, III et al., for “Automatically Adaptable Fastening System for Wheeled Cots and Similar Devices”;
U.S. Pat. No. 5,344,265, issued Sep. 6, 1994 to Ullman et al., for “Securement System for a Rollable Mobility Aid”;
U.S. Pat. No. 5,628,595, issued May 13, 1997 to Harris, for “Wheelchair Lock-Down Device”; and
U.S. Pat. No. 6,352,396, issued Mar. 5, 2002 to Budd et al., for “Automatic Wheelchair Restraining Device”.

However, the aforesaid designs suffer from a number of significant disadvantages. The housings for most of the designs are bulky and do not appear to permit easy maneuvering of the wheelchair within the vehicle. The locking devices used in the housings are complex and may require extensive modification to either the wheelchair or the vehicle. This may be prohibitively expensive, which may decrease the accessibility of the designs to most users. In addition, some of the locking devices have exposed guide mechanisms, which may trap dirt requiring regular cleaning and maintenance. Moreover, the exposed mechanisms may pose danger from trapping articles of clothing or body parts.

Thus, there is a need for an improved wheelchair locking device for use in a vehicle.

### SUMMARY OF THE INVENTION

The present invention reduces the difficulties and disadvantages of the aforesaid designs by providing a locking device, which is housed in a cylindrical housing. The cylindrical housing advantageously significantly reduces or essentially eliminates the aforesaid problems of inefficient space use due to excessive bulk. Moreover, the shape of the housing permits the wheelchair user free, unrestricted maneuverability about the housing during initial embarking in a vehicle. The locking device is mounted within the housing and is hidden from view so that danger from catching clothing and the like is significantly reduced. Moreover, the locking device securely holds a wheelchair locking pin using a novel mating assembly of plates which are resiliently biased into engagement. A retaining barrier ensures that the locking pin is held firmly between the mated plates. The locking device may be released using either a simple mechanical or electrical operation. The housing with the locking device may be retrofitted into an existing vehicle without the need for extensive modification to either the wheelchair or to the vehicle. Furthermore, the locking device is easy to operate and inexpensive to install.

In accordance with a first embodiment of the present invention, there is provided a locking device for mounting a wheelchair in a vehicle, the wheelchair having a downwardly depending locking pin, the device comprising: a) two plate members; b) a connecting portion for connecting the plate members, the plate members being movable with respect to each other about the connecting portion, the plate members being mateable together so as to retain the locking pin therebetween.

In accordance with another embodiment of the present invention, there is provided a wheelchair locking apparatus for use in a vehicle, the apparatus comprising: a) a housing having a top wall and a sidewall, the top wall and the sidewall defining an inner chamber for mounting a locking device therein, the housing being shaped to permit unrestricted movement of the wheelchair about the housing when the wheelchair engages the locking device; b) a guide way located in the sidewall and the top wall, the guide way having a wide portion and a narrow portion, the narrow portion being cooperable with a wheelchair locking pin; c) a connecting portion connected to the sidewall, the connecting portion having a flange for connecting the housing to a floor of the vehicle.

### BRIEF DESCRIPTION OF THE DRAWINGS

Further aspects and advantages of the present invention will become better understood with reference to the description in association with the following Figures, in which:

FIG. 1 is a perspective view of a vehicle showing an embodiment of a locking device engaging a wheelchair;

FIG. 2 is a simplified perspective view of an apparatus housing the locking device in a locking configuration;

FIG. 2a is a perspective bottom view of the apparatus showing the locking device;

FIG. 3 is an exploded view of the apparatus and the locking device;

FIG. 4 is a simplified exploded view of the locking device;

FIG. 5a is a simplified perspective view of the locking device in a default configuration;

FIG. 5b is a simplified perspective view of the locking device in an intermediate configuration;

FIG. 5c is a simplified perspective view of the locking device in a locking configuration; and

FIG. 6 is a simplified perspective view of the locking device showing a hinge connection.

### DETAILED DESCRIPTION OF THE PREFERRED EMBODIMENT

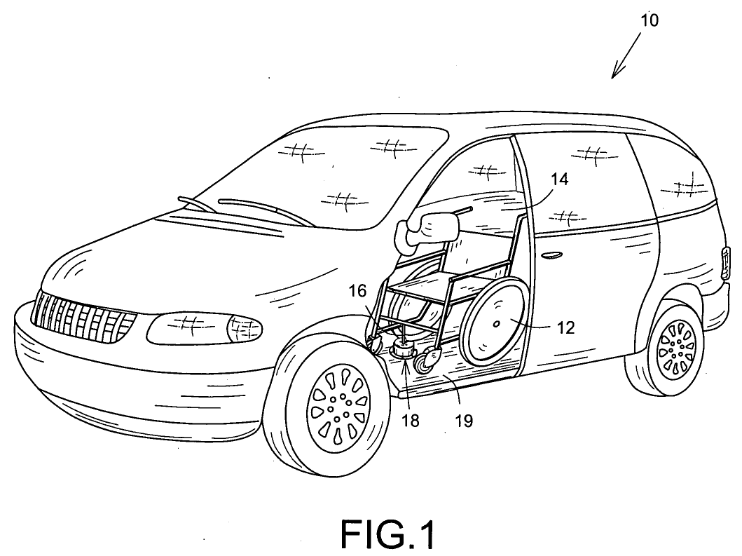

Referring to FIGS. 1 to 3, a vehicle, such as a minivan and the like, is shown generally at 10. The vehicle 10 is typically adapted to permit access of a wheelchair 12 into an interior 14 of the vehicle 10. The wheelchair 12 includes a downwardly depending locking pin 16 connected to the wheelchair frame and is typically an elongate shaft with a nut connected to an end furthest away from the wheelchair frame. A housing apparatus 18 is connected to a floor 19 of the vehicle 10 and houses a locking device 20 for mounting and retaining the wheelchair 12 in the vehicle 10. The housing 18 is located in the interior 14 of the vehicle 10 and includes a top wall 22 and a sidewall 24. The top wall 22 and the sidewall 24 define an inner chamber 26 for mounting the locking device 20 therein. The sidewall 24 and the top wall 22 are shaped to permit the wheelchair 12 unrestricted rotation thereabout at a time when the locking pin 16 is engaging the locking device 20, such as when a user first enters the interior 14 of the vehicle 10 and is maneuvering the wheelchair 12. Moreover, the housing 18 is sufficiently sized to enable the wheels of the wheelchair 12 unrestricted movement around the housing 18. In the embodiment illustrated, the housing shape is cylindrical, but one skilled in the art will recognize that the housing may also be elliptical. A guide way 28 is located in the sidewall 24 and the top wall 22 and includes a narrow portion 30 located in the top wall 22 and a wide portion 32 located in the sidewall 24. The narrow portion 30 is cooperable with the locking pin 16, extends towards the center of the top wall 22, and includes a stopping end 33 against which the locking pin 16 abuts and stops. The wide portion 32 is typically V-shaped. A connecting portion 34 is connected to the sidewall 24 and includes a partial circumferentially disposed flange 36, which extends around the base of the sidewall 24 and connects the housing 12 to the vehicle's floor 19. A pair of mounting shafts 38, 39 are connected to the top wall 22 and extend into the inner chamber 26. The mounting shafts 38, 39 are spaced apart and are located on either side of the narrow portion 30 of the guide way 28. The mounting shafts 38, 39 are typically bolts and may have an unthreaded portion (not shown) to permit easy rotation of the plate members with respect to each other.

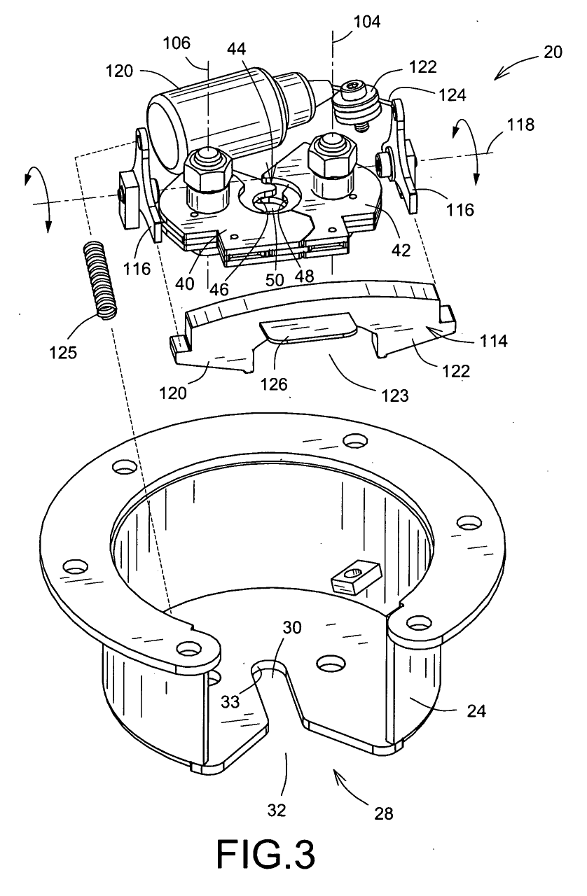

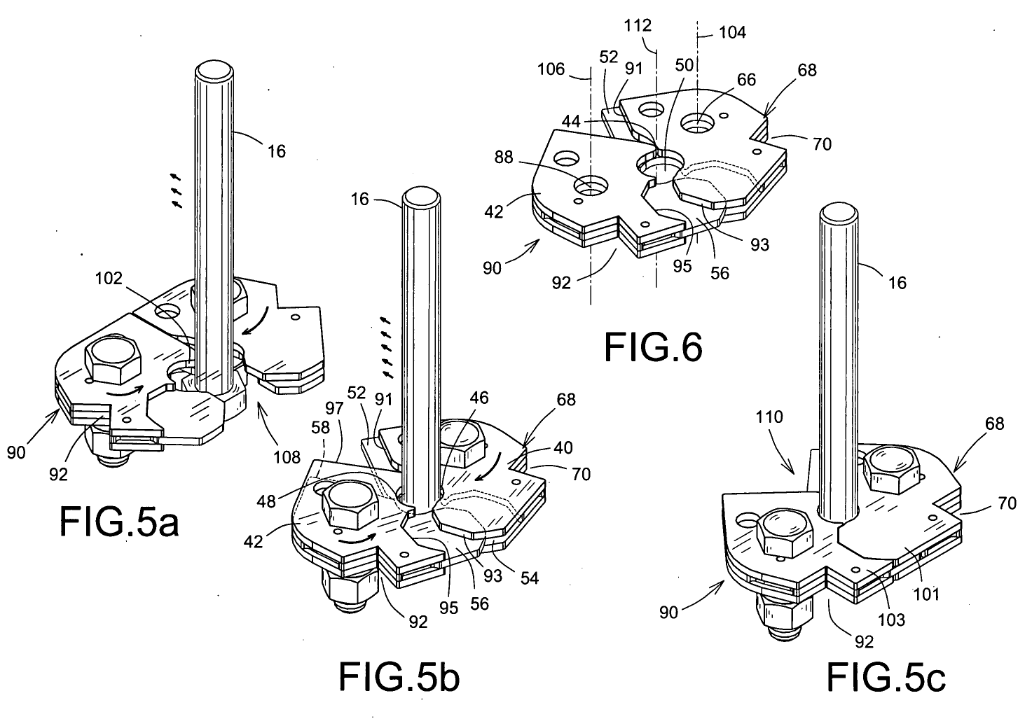

Referring to FIGS. 3, 5, 5a, 5b, and 5c, in broad terms, the locking device 20 of the present invention is a spring-loaded mechanism and includes two plate members 40, 42, which are connected together via a connecting portion 44. The plate members 40, 42 are movable with respect to each other about the connecting portion 44 and mate together in an interleaving manner to retain the locking pin 16 therebetween in a locking configuration, as best seen in FIG. 5c. To retain the locking pin 16, each of the plate members 40, 42 have a locking indent 46, 48 located in opposing sides of the plate members 40, 42. The locking indents 46, 48 are each arcuate and when the plate members 40, 42 mate together, the locking indents 46, 48 form a generally circular locking opening 50, which cooperates with the locking pin 16.

As best illustrated in FIGS. 5a, 5b, and 5c, the first plate member 40 includes a first tongue 52 and a first slot 54. The second plate member 42 includes a second tongue 56 and a second slot 58. The first tongue 52 and the first slot 54 are located on either side of the first locking indent 46. The second tongue 56 and the second slot 58 are located on either side of the second locking indent 48. The tongues 52, 56 and the slots 54, 58 are located on opposing sides of the first and second plate members 40, 42. One skilled in the art will recognize that while two tongues and two slots are illustrated throughout, it is envisaged that one tongue in one plate member and one slot located in the other plate member would also be sufficient and would not deviate from the scope of the invention.

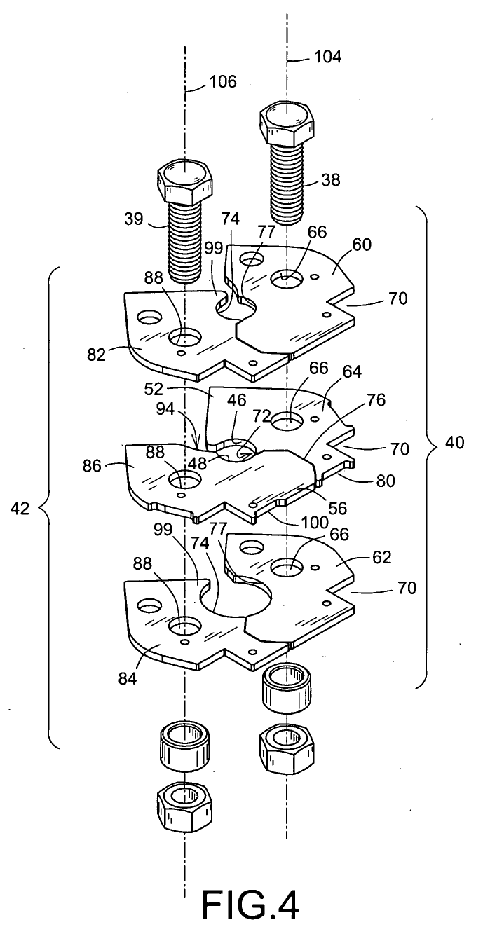

Referring now to FIGS. 4 and 6, the first plate member 40 includes a first upper plate 60, a first lower plate 62, and a first middle plate 64 sandwiched between the upper and lower plates 60, 62. A first plate opening 66 extends through the upper, lower and middle plates and rotatably mounts the first plate member 40 on the mounting shaft 38. Each of the first upper, first lower and first middle plates 60, 62, 64, when sandwiched, define a first common outer edge 68 and a first common recess 70 located in the first common outer edge 68. The first middle plate 64 has an inner edge 72 with the first locking indent 46 and a recess 76, and a front edge 80 located between the first common recess 70 and the recess 76. The first upper and lower plates 60, 62 each include an arcuate portion 77, which are larger than the first locking indent 46 of the first middle plate 64. The inner edge 72 extends away from between the first upper and lower plates 60,62 and forms the first tongue 52. The upper and lower plates 60, 62 and the recess 76 define the first slot 54. A first contacting portion 102 for contacting the locking pin 16 is located adjacent the first locking indent 46.

The second plate member 42 includes a second upper plate 82, a second lower plate 84 and a second middle plate 86 sandwiched between the upper and lower plates 82, 84. A second plate opening 88 extends through the upper, lower and middle plates 82, 84, 86, and rotably mounts the second plate member 42 on the mounting shaft 39. Each of the second upper, second lower and second middle plates 82, 84, 86, when sandwiched, defines a second common outer edge 90 and a second common recess 92 located in the second common outer edge 90. The second middle plate 86 has an inner edge 94 with the second locking indent 48 and a front edge 100 located adjacent the second common recess 92. The inner edge 94 extends away from between the second upper and lower plates 82, 84 and forms the second tongue 56. The second upper and lower plates 82, 84 define the second slot 58. The second upper and lower plates 82, 84 include a second contacting portion 99 located adjacent the second locking indent 48, which together with the first contacting portion 102 permit the locking pin 16 to push thereagainst to move the first and second plate members 40, 42 from the default configuration to the locking configuration.

The first and second plate openings have respective first and second opening axes 104, 106, which are disposed parallel to each other. The second upper and lower plates 82, 84 each include an arcuate portion 74, which are larger than the second locking indent 48. The arcuate portions 77 of the first plate 30 member and the arcuate portions 74 of the second plate member 82, when combined in the locking configuration form corresponding upper and lower circular openings, which are larger than the locking opening 50. The upper and lower circular openings may cooperate with the nut of the locking pin 16 to further secure the locking pin in the locking device 20.

The first tongue 52 and the second slot 58 are sized and shaped to permit mating in a default configuration. The first slot 54 and the second tongue 56 are spaced apart and define a frontwardly disposed gap 108 therebetween of sufficient size to receive the locking pin 16. The second tongue 56 and the first slot 54 are sized and shaped to permit mating in a locking configuration. The first tongue 52 and the second slot 58 are spaced apart and define a rearwardly disposed V-shaped gap 110, as best illustrated in FIG. 5c.

The connecting portion 44 is a hinge connection, which permits hingeable movement of the plate members 40, 42 about the hinge between default and locking configurations. The connecting portion 44 is formed by a partial mating connection between the first tongue 52 and the second slot 58 adjacent the first and second contacting portions 99, 102. The hinge has a hinge axis 112, which is disposed parallel to the first and second opening axes 104, 106.

The first upper plate 60, the first lower plate 62 and the first tongue 52 together define a first stopping portion 91. The first upper plate 60, the first lower plate 62 and the first slot 54 together define a second stopping portion 93. The second upper plate 82, the second lower plate 84 and the second tongue 56 together define a third stopping portion 95. The second upper plate 82, the second lower plate 84 and the second slot 58 together define a fourth stopping portion 97. The second stopping portion 93 and the third stopping portion 95 abuttingly engage each other in the locking configuration. The first stopping portion 91 and the fourth stopping 97 abuttingly engage each other in the default configuration. The second stopping portion 93 and the third stopping portion 95 are complementary and the first stopping portion 91 and the fourth stopping 97 are complementary. The first and second plate members 40, 42 each include a supporting portion 101, 103 which are disposed towards the guide way 28.

As best illustrated in FIG. 4, the first upper plate 60 and the first lower plate 62 of the first plate member 40, and the second middle plate 86 of the second plate member 42 are identically shaped. The second upper plate 82 and the second lower plate 84 of the second plate member 42, and the first middle plate 52 of the first plate member 40 are identically shaped.

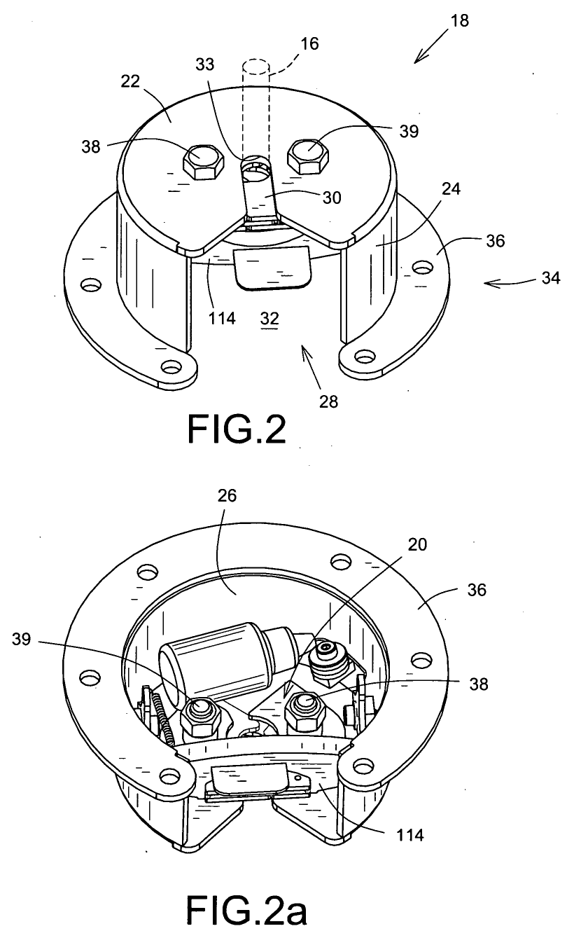

Referring now to FIGS. 2a and 3, a retaining barrier 114, which is adapted to cooperate with the plate members, is resiliently biased towards the plate members 40, 42 and keeps the plate members 40, 42 in the default configuration. The barrier 114 is mounted in the housing and located adjacent the plate members 40, 42 and the guide way 28. The barrier 114 is hingeably moveable with respect to the plate members 40, 42 to permit movement of the plate members between default and locking configurations. The barrier 114 includes a hinge portion 116 with a hinge axis 118. The hinge axis 118 is disposed perpendicular to the plate opening axes 104, 106. The barrier 114 includes a pair of panel members 120, 122 and an arch 123 defined by the panel members 120, 122. The supporting portions 101, 103 of the plate members 40, 42 support the panel members 120, 122 in the default configuration so that the arch 123 cooperates with the common recesses 70, 92. The barrier 114 includes a resilient spring 125 for resiliently biasing the barrier 114 into contact with the plate members 40, 42. The spring 125 is connected to an inner portion of the sidewall 24 of the housing 18 and to the hinge 116. A solenoid 120 is connected via a wheel 122 and a wire 124 to the hinge 116 and is typically used to electrically operate the barrier 114 to release the locking pin 16. A hand-operated switch (not shown) extends from the solenoid 120 for the user to remotely operate the barrier 114. If desired, the barrier 114 may also include an extension 126 located adjacent the barrier arch 124 which may be used to manually operate the barrier 114. The extension 126 permits the user to push down on the extension 126 to release the locking pin 16 from the locking device 20. A sensor (not shown) may also be connected to the barrier 114 and in communication with an LED display in the cab of the vehicle 10 for signaling to the driver of the vehicle 10 that the wheelchair 12 is locked into the locking device 20.

Operation

Referring now to FIGS. 1, 5a, 5b, and 5c, a typical operation of the locking device 20 of the present invention will now be described.

The wheelchair user enters the interior 14 of the vehicle 10 and maneuvers the wheelchair 12 about the housing 18 until the downwardly depending locking pin 16 moves into the guide way 28 where it is guided into engagement with the locking device 20. The plate members 40, 42 are in the default configuration such that the frontwardly disposed gap 108 is able to receive the locking pin 16. The locking pin 16 is moved into the narrow portion 30 of the guide way 28 and abuttingly engages the contacting portions 99, 102 located adjacent the stopping portion 33 of the narrow portion 30 of the guide way 28. The locking pin 16 pushes against the contacting portions 99, 102 with sufficient force to cause the plate members 40, 42 to both rotate about their respective mounting shafts 38, 39 towards each other and to hingeably move about the hinge portion 44 so that the first tongue 56 and the second slot 54 move towards each other. The supporting portions 101, 103 of each of the plate members 40, 42 slide against the panel members 120, 122 of the barrier 114 and towards each other until the panel members 120, 122 reach the two common recesses 70, 92. The barrier 114 is then resiliently biased to engage the common recesses 70, 92 and the supporting portions 101, 103 cooperate with the arch 123. The first and second locking indents 46, 48 together encircle the locking pin 16 and form the locking opening 50. The locking opening 50 and the barrier 114 in a down position form the locking configuration, which retains the locking pin 16. When the wheelchair user desires to be released from the locking device 20, either the solenoid 120 is activated using the hand-operated switch or the extension 126 is pushed down against. This causes the barrier 114 to hingeably move away from the supporting portions 101, 103 of the plate members 40, 42 and the locking pin 16 may freely move against the locking indents 44, 46 to unmate the first tongue 52 and the second slot 58. The plate members 40, 42 then freely rotate and hinge away from each other to release the locking pin 16, which disengages the guide way 28 and allows the wheelchair 12 to move away from the locking device 20.

While a specific embodiment has been described, those skilled in the art will recognize many alterations that could be made within the spirit of the invention, which is defined solely according to the following claims.

1. A locking device for mounting a wheelchair in a vehicle, the wheelchair having a downwardly depending locking pin, the device comprising:
a) two plate members;
b) a connecting portion for connecting the plate members, the plate members being movable with respect to each other about the connecting portion, the plate members being mateable together so as to retain the locking pin therebetween.

2. The device, according to claim 1, in which:
a) each plate member has a locking indent located in opposing sides of the plate members, the locking indents forming a locking opening when the plate members are moved together, the locking opening being cooperable with the locking pin.

3. The device, according to claim 1, in which:
a) the first plate member has at least one tongue;
b) the second plate member has at least one slot, the tongue and the slot being located on opposing sides of the first and second plate members.

4. The device, according to claim 1, in which:
a) the first plate member has at least one slot;
b) the second plate member has at least one tongue, the tongue and the slot being located on opposing sides of the first and second plate members.

5. The device, according to claim 3 or 4, in which:
a) the first plate member includes a first tongue and a first slot;
b) the second plate member includes a second tongue and a second slot.

6. The device, according to claim 5, in which:
a) the plate members have respective first and second locking indents located on opposing sides of the plate members;
b) the first tongue and the first slot are located on either side of the first locking indent;
c) the second tongue and the second slot are located on either side of the second locking indent.

7. The device, according to claim 6, in which:
a) the first tongue and the second slot are sized and shaped to permit mating in a default configuration, the first slot and the second finger being spaced apart and define a frontwardly disposed gap therebetween of sufficient size for receiving therein the locking pin.

8. The device, according to claim 6, in which:
a) the second tongue and the first slot are sized and shaped to permit mating in a locking configuration, the first tongue and the second slot being spaced apart and define a rearwardly disposed V-shaped gap.

9. The device, according to claim 1, in which:
a) the plate members are hingeably connected to permit movement of the plates between default and locking configurations.

10. The device, according to claim 9, in which:
a) the plate members are hingeably connected by a hinge, the hinge having a hinge axis, the plate members being movable about the hinge.

11. The device, according to claim 1, in which:
a) the first plate member includes a first plate opening for rotably mounting the first plate member on a first mounting shaft;
b) the second plate member includes a second plate opening for rotably mounting the second plate member on a second mounting shaft, the first and second mounting shafts being spaced apart.

12. The device, according to claim 11, in which:
a) the first and second plate openings have respective first and second opening axes, the first and second opening axes being disposed parallel to each other.

13. The device, according to claim 12, in which:
a) the first and second mounting shafts are located in a housing.

14. The device, according to claim 1, in which:
a) the plate members are hingeably connected by a hinge, the hinge having a hinge axis;
b) the first and second plate members have respective first and second plate openings, the first and second plate openings having respective first and second opening axes, the hinge axis and the first and second opening axes being disposed parallel to each other.

15. The device, according to claim 14, in which:
a) the first and second plate members are rotably mounted on respective first and second spaced apart mounting shafts, the first and second plate members being rotatable about their respective mounting shafts and the hinge to permit movement of the first and second plate members between default and locking configurations.

16. The device, according to claim 15, in which:
a) the first and second mounting shafts are located in a housing.

17. The device, according to claim 1, in which:
a) a contacting portion for contacting the locking pin is located between first and second plate members, the locking pin pushing against the contacting portion to move the first and second plate members from the default configuration to the locking configuration.

18. The device, according to claim 17, in which:
a) the first and second plate members each have first and second plate openings for rotably mounting the plate members on respective first and second spaced apart mounting shafts.

19. The device, according to claim 18, in which:
a) the first and second mounting shafts are located in a housing.

20. The device, according to claim 1, further includes:
a) a retaining barrier cooperable with the plate members, the barrier being resiliently biased towards the plate members for keeping the plate members in a default configuration.

21. The device, according to claim 20, in which:
a) the barrier is hingeably moveable with respect to the plate members to permit movement of the plate members between default and locking configurations.

22. The device, according to claim 21, in which:
a) the barrier includes a hinge portion, the hinge portion having a hinge axis.

23. The device, according to claim 22, in which:
a) the plate members each have first and second plate openings, with respective plate opening axes, the plate opening axes being disposed parallel to each other, the hinge axis being disposed perpendicular to the opening axes.

24. The device, according to claim 23, in which:
a) the plate members each have a recess located in an outer edge;
b) the barrier includes a pair of panel members and an arch defined by the panel members, the plate members being supported by the panel members in a default configuration, the arch cooperating with the panel members in a locking configuration.

25. The device, according to claim 23, in which:
a) the barrier includes a resilient spring for resiliently biasing the barrier into contact with the plate members.

26. The device, according to claim 23, in which:
a) the barrier includes a solenoid for electrically operating the barrier.

27. The device, according to claim 23, in which:
a) the barrier includes an extension for manually operating the barrier, the extension being located adjacent the barrier arch.

28. The device, according to claim 24, in which:
a) the barrier is mounted in a housing and located adjacent the plate members.

29. The device, according to claim 1, further comprising:
a) a housing having a guide way disposed in the housing for guiding the locking pin into the housing, and a connecting portion for connecting the housing to a floor of the vehicle, the plate members being mounted in the housing adjacent the guide way.

30. The device, according to claim 29, in which:
a) two spaced apart mounting shafts are located on either side of the guide way, the plate members each having plate openings for mounting the plate members on the mounting shafts.

31. The device, according to claim 30, in which:
a) a retaining barrier is hingeably connected to the housing and located adjacent the guide way, the barrier being resiliently biased into contact with the first and second plate members to keep the barrier in the default configuration, the barrier being resiliently biased into cooperation with the plate members in the locking configuration.

32. The device, according to claim 31, in which:
a) a resilient spring is connected to the barrier and the housing to resiliently bias the barrier into contact with the first and second plate members.

33. The device, according to claim 31, in which:
a) a solenoid is mounted in the housing and connected to the barrier for electrically moving the barrier away from the first and second plate members.

34. The device, according to claim 29, in which:
a) the housing is cylindrical.

35. The device, according to claim 2, in which:
a) the first and second locking indents are both arcuate portions which together from a circular opening of sufficient size to cooperate with the locking pin.

36. The device, according to claim 1, in which the first plate member includes:
a) a first upper plate;
b) a first lower plate;
c) a first middle plate sandwiched between the upper and lower plates;
d) a first plate opening extending through the upper, lower and middle plates.

37. The device, according to claim 36, in which each of the first upper, first lower and first middle plates, when sandwiched, define:
a) a first common outer edge;
b) a first common recess located in the first common outer edge.

38. The device, according to claim 36, in which the first middle plate has:
a) an inner edge with an arcuate portion and a recess;
b) a front edge located between the first common recess and the recess
c) a first contacting portion for contacting the locking pin, the contacting portion being located adjacent the arcuate portion.

39. The device, according to claim 38, in which:
a) the inner edge extends away from between the first upper and lower plates and forms a first tongue;
b) the upper and lower plates and the recess define a second slot.

40. The device, according to claim 1, in which the second plate member includes:
a) a second upper plate;
b) a second lower plate;
c) a second middle plate sandwiched between the upper and lower plates;
d) a second plate opening extending through the upper, lower and middle plates.

41. The device, according to claim 40, in which each of the second upper, second lower and second middle plates, when sandwiched, define:
a) a second common outer edge;
b) a second common recess located in the second common outer edge;
c) the second upper plate and the second lower plate together forming a second contacting portion.

42. The device, according to claim 40, in which the second middle plate has:
a) an inner edge with an arcuate portion and a recess;
b) a front edge located between the second common recess and the recess.

43. The device, according to claim 42, in which:
a) the inner edge extends away from between the second upper and lower plates and forms a second tongue;
b) the upper and lower plates and the recess define a first slot.

44. The device, according to claims 39 and 43, in which:
a) in a locking configuration, the first tongue and the second slot are mated, the second tongue and the first slot being spaced apart and form a V-shaped gap therebetween.

45. The device, according to claim 44, in which:
a) in a default configuration, the second tongue and the first slot are mated, the first tongue and the second slot being spaced apart.

46. The device, according to claim 45, in which:
a) the first upper plate, the first lower plate and the first tongue define a first stopping portion;
b) the first upper plate, the first lower plate and the first slot define a second stopping portion;
c) the second upper plate, the second lower plate and the second tongue define a third stopping portion;
d) the second upper plate, the second lower plate and the second slot define a fourth stopping portion;
e) the second stopping portion and the third stopping portion being abuttingly engaged in the locking configuration;
f) the first stopping portion and the fourth stopping being abuttingly engaged in the default configuration.

47. The device, according to claim 46, in which:
a) the second stopping portion and the third stopping portion are complementary;
b) the first stopping portion and the fourth stopping are complementary.

48. The device, according to claim 1, in which:
a) the first and second plate members each include a supporting portion;
b) a retaining barrier is hingeably mounted in a housing, the barrier being supported by the supporting portion of each plate member in a default configuration.

49. The device, according to claims 26 and 30, in which:
a) the first upper plate and the first lower plate of the first plate member, and the second middle plate of the second plate member are identically shaped;
b) the second upper plate and the second lower plate of the second plate member, and the first middle plate of the first plate member are identically shaped.

50. A locking device for mounting a wheelchair in a vehicle, the wheelchair having a downwardly depending locking pin, the device comprising:
a) a housing mounted on a floor of the vehicle;
b) a spring loaded locking mechanism located in the housing, the mechanism including two mateable plate members and a retaining barrier, the plate members being mounted in the housing and rotable with respect to each other, the barrier resiliently biasing the plate members together, the plate members cooperating with the locking pin to retain the lock pin therebetween.

51. A locking device for mounting a wheelchair in a vehicle, the wheelchair having a downwardly depending locking pin, the device comprising:
a) a housing mounted on a floor of the vehicle;
b) a spring loaded locking mechanism located in the housing, the mechanism including two mateable plate members and a retaining barrier, the plate members being mounted in the housing and hingeable with respect to each other, the barrier resiliently biasing the plate members together, the plate members cooperating with the locking pin to retain the lock pin therebetween.

52. A locking device for mounting a wheelchair in a vehicle, the wheelchair having a downwardly depending locking pin, the device comprising:
a) a housing mounted on a floor of the vehicle;
b) a spring loaded locking mechanism located in the housing, the mechanism including two mateable plate members and a retaining barrier, the plate members being hingeably connected and rotably mounted in the housing, the plate members being hingeable and rotable with respect to each other, the barrier resiliently biasing the plate members together, the plate members cooperating with the locking pin to retain the lock pin therebetween.

53. The device, according to claim 52, in which:
a) each plate member has a locking indent located on opposing sides of the plate members, the locking indents together form a locking opening which cooperates with the locking pin.

54. The device, according to claim 53, in which:
a) each plate member has at least one tongue and at least one slot.

55. The device, according to claim 54, in which:
a) the first plate member has a first tongue and a first slot;
b) the second plate member has a second tongue and a second slot, the first tongue being mateable with the second slot, the second tongue being mateable with the first slot in a locking configuration.

56. A wheelchair locking apparatus for use in a vehicle, the apparatus comprising:
a) a housing having a top wall and a sidewall, the top wall and the sidewall defining an inner chamber for mounting a locking device therein, the housing being shaped to permit unrestricted movement of the wheelchair about the housing when the wheelchair engages the locking device;
b) a guide way located in the sidewall and the top wall, the guide way having a wide portion and a narrow portion, the narrow portion being cooperable with a wheelchair locking pin;
c) a connecting portion connected to the sidewall, the connecting portion having a flange for connecting the housing to a floor of the vehicle.

57. The apparatus, according to claim 56, in which:
a) the housing is cylindrical.

58. The apparatus, according to claim 56, in which the flange is partially circumferentially disposed.
